(19) United States
(12) Patent Application Publication
(10) Pub. No.: US 2023/0189092 A1
(43) Pub. Date: Jun. 15, 2023

(54) METHOD AND APPARATUS FOR MASTER CELL GROUP LINK RECOVERY CONSIDERING CONDITIONAL HANDOVER AND LISTEN BEFORE TALK

(71) Applicant: Lenovo (Beijing) Ltd., Beijing (CN)

(72) Inventors: Haiming WANG, Beijing (CN); Haipeng LEI, Beijing (CN); Joachim LÖHR, Wiesbaden (DE); Lianhai WU, Beijing (CN)

(73) Assignee: Lenovo (Beijing) Ltd., Beijing (CN)

(21) Appl. No.: 17/919,514

(22) PCT Filed: Apr. 17, 2020
(86) PCT No.: PCT/CN2020/085402

§ 371 Date: Oct. 17, 2022

(51) Int. Cl. H04W 36/00

(52) U.S. Cl. CPC H04W 36/0079; H04W 36/0058

(57) ABSTRACT

Embodiments of the present application relate to a method and an apparatus for for master cell group (MCG) link recover considering conditional handover (CHO) and listen before talk (LBT). According to an embodiment of the present application, a method can include: receiving MCG link recovery configuration information; in response to a RLF in a MCG, starting a first timer associated with a fast MCG link recovery procedure and transmitting MCG failure information including a failure type, wherein the failure type indicates that the RLF in the MCG is due to one of: an out-of-sync timer expires; a random access problem occurs; a maximum number of retransmissions has been reached; and a consistent uplink LBT failure is detected. Embodiments of the present application can define the UE behavior for the fast MCG link recovery when considering CHO and LBT.

### TECHNICAL FIELD

Embodiments of the present application generally relate to wireless communication technology, especially to a method and an apparatus for master cell group (MCG) link recovery considering conditional handover (CHO) and listen before talk (LBT).

### BACKGROUND

In 3rd generation partnership project (3GPP) Release 16, a MCG link recovery procedure is introduced. The purpose of this procedure is to inform a radio link failure (RLF) in a MCG to a master node (MN), such that a user equipment (UE) in RRC_CONNECTED state may quickly perform a MCG link recovery procedure to continue the radio resource control (RRC) connection without performing a re-establishment procedure.

In addition, a CHO procedure is defined as a handover procedure that is executed by a UE when one or more handover execution conditions are met. In the CHO procedure, the UE may start evaluating execution condition(s) after receiving the CHO configuration information, and stop evaluating the execution condition during the CHO execution once the execution condition(s) is met.

Moreover, in 3GPP 5G new radio (NR) technology, a LBT technique is introduced for transmission on an unlicensed spectrum. Only when LBT is successful, can the transmitter start the transmission on the channel and occupy the channel. Otherwise, the transmitter cannot start the transmission and will continue performing LBT until a successful LBT is obtained.

The UE may be able to perform the above three processes. However, how to handle the association between a fast MCG link recovery procedure and a CHO procedure and between the fast MCG link recovery procedure and the LBT has not been discussed in 3GPP 5G NR technology yet.

Therefore, the industry desires an improved technology for fast MCG link recovery considering CHO and LBT, so as to define the UE behaviour for the fast MCG link recovery when considering CHO and LBT.

### SUMMARY

Some embodiments of the present application provide a technical solution for fast MCG link recovery considering CHO and LBT.

According to some embodiments of the present application, a method may include: receiving MCG link recovery configuration information; in response to a RLF in a MCG, starting a first timer associated with a fast MCG link recovery procedure and transmitting MCG failure information including a failure type, wherein the failure type indicates that the RLF in the MCG is due to one of: an out-of-sync timer expires; a random access problem occurs; a maximum number of retransmissions has been reached; and a consistent uplink LBT failure is detected.

According to some other embodiments of the present application, a method may include: transmitting MCG link recovery configuration information; receiving MCG failure information including a failure type, wherein the failure type indicates that a RLF in a MCG is due to one of: an out-of-sync timer expires; a random access problem occurs; a maximum number of retransmissions has been reached; and a consistent uplink LBT failure is detected.

Some embodiments of the present application also provide an apparatus, include: at least one non-transitory computer-readable medium having computer executable instructions stored therein, at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

Embodiments of the present application provide a technical solution for fast MCG link recovery considering CHO and LBT. Accordingly, embodiments of the present application can define the UE behaviour for the fast MCG link recovery when considering CHO and LBT.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of a fast MCG link recovery procedure in accordance with some embodiments of the present application;

FIG. 3 illustrates an exemplary flowchart of a CHO procedure in accordance with some embodiments of the present application;

FIG. 4 illustrates a flow chart of a method for fast MCG link recovery considering CHO and LBT in accordance with some embodiments of the present application;

FIG. 5 illustrates a flow chart of a method for fast MCG link recovery considering CHO and LBT in accordance with some other embodiments of the present application;

FIG. 6 illustrates a simplified block diagram of an apparatus 600 for fast MCG link recovery considering CHO and LBT according to some embodiments of the present application; and

FIG. 7 illustrates a simplified block diagram of an apparatus 700 for fast MCG link recovery considering CHO and LBT according to some other embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

Next generation radio access network (NG-RAN) supports multi-radio dual connectivity (MR-DC) operation. In the MR-DC operation, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3GPP standard documents), and at least the MN is connected to the core network.

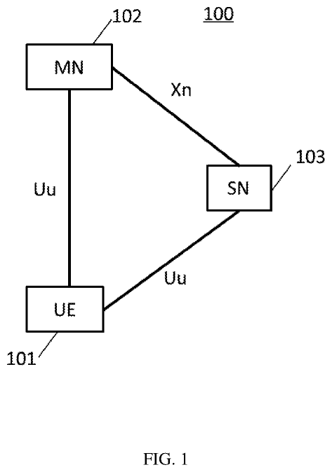

For example, FIG. 1 illustrates a schematic diagram of a wireless communication system in accordance with some embodiments of the present application.

As shown in FIG. 1, the wireless communication system 100 may be a dual connectivity system 100 including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via a network interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1). The UE 101 may be configured to utilize resources provided by the MN 102 and the SN 103 to perform data transmission.

The MN 102 may refer to a radio access node that provides a control plane connection to the core network. In an embodiment of the present application, in the E-UTRA-NR DC (EN-DC) scenario, the MN may be an eNB. In another embodiment of the present application, in the next generation E-UTRA-NR DC (NGEN-DC) scenario, the MN may be an ng-eNB. In yet another embodiment of the present application, in the NR-DC scenario or the NR-E-UTRA DC (NE-DC) scenario, the MN may be a gNB.

The MN may be associated with a MCG. The MCG may refer to a group of serving cells associated with the MN, and may include a primary cell (PCell) and optionally one or more secondary cells (SCells). The PCell may provide a control plane connection to the UE 101.

The SN 103 may refer to a radio access node without control plane connection to the core network but providing additional resources to the UE 101. In an embodiment of the present application, in the EN-DC scenario, the SN may be an en-gNB. In another embodiment of the present application, in the NE-DC scenario, the SN may be a ng-eNB. In yet another embodiment of the present application, in the NR-DC scenario or the NGEN-DC scenario, the SN may be a gNB.

The SN 103 may be associated with a secondary cell group (SCG). The SCG may refer to a group of serving cells associated with the SN 103, and may include a primary secondary cell (PSCell) and optionally one or more secondary cells (SCells).

The PCell of the MCG and the PSCell of the SCG may also be referred to as a special cell (SpCell).

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In 3GPP Release 16, a fast MCG link recovery procedure is introduced for MR-DU. The purpose of this procedure is to inform a RLF in a MCG to the MN via a SN connected to the UE, such that the UE in RRC_CONNECTED state may initiate the fast MCG link recovery procedure to quickly continue the RRC connection without performing a re-establishment procedure.

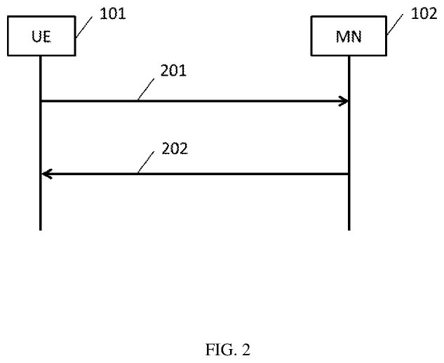

For example, FIG. 2 illustrates an exemplary flowchart of a fast MCG link recovery procedure in accordance with some embodiments of the present application.

As shown in FIG. 2, in the case that a RLF in a MCG for the UE 101 happens, the UE 101 may initiate (or, trigger) a fast MCG link recovery procedure. For example, in step 201, the UE 101 may transmit a message associated with the RLF to the MN 102 via the SN 103. In an embodiment of the present application, the RLF in the MCG may refer to the RLF happening in the PCell of the MCG. In an embodiment of the present application, the message associated with the RLF in step 201 may be a MCGFailureInformation message as specified in 3GPP standard documents. The UE 101 may not directly transmit the message associated with the RLF to the MN 102. Instead, the UE 101 may transmit the message associated with the RLF to the SN 103, and then the SN 103 may transfer the message received from the UE to the MN 102.

For example, the UE 101 may be configured with a split signaling radio bearer SRB1 or SRB3 to report the MCG failure information when a RLF in the MCG happens. In the case that split SRB1 is configured, the UE 101 may submit the MCGFailureInformation message to lower layers, e.g., for transmission via SRB1. In the case that SRB3 is configured, the UE 101 may submit the MCGFailureInformation message to lower layers for transmission via SRB3. For example, the MCGFailureInformation message may be embedded in NR RRC message ULInformationTransferMRDC as specified in 3GPP standard documents for transmission via SRB3.

When or after transmitting the message in step 201, the UE 101 may start a timer associated with a fast MCG link recovery procedure. In an embodiment of the present application, the timer associated with a fast MCG link recovery procedure may be T316 as specified in 3GPP standard documents.

After receiving the message associated with the RLF, in step 202, the MN 102 may transmit a response message to the UE 101. The response message in step 202 may be a RRC reconfiguration message including a handover (HO) command for a cell or a RRC release message. In an embodiment of the present application, the handover command may be a reconfigurationWithSync configuration as specified in 3GPP standard documents. The MN 102 may not directly transmit the response message to the UE 101. Instead, the MN 102 may transmit the response message to the SN 103 as shown in FIG. 1, and then the SN 103 may transfer the response message to the UE 101.

For example, in the case that SRB3 is configured for transmitting the message associated with the RLF, after receiving the response message from the MN 102, the SN 103 may encapsulate the response message in a DLInformationTransferMRDC message as specified in 3GPP standard documents, and then transmit the DLInformationTransferMRDC message to the UE 101.

Before the timer, e.g., T316 expires, in the case that the UE 101 receives one of the RRC reconfiguration message and the RRC release message, the UE 101 may stop the timer, which means that the fast MCG link recovery procedure would be terminated. In the case that the UE 101 receives the RRC reconfiguration message including handover command for a cell, the UE 101 may perform handover for the UE 101 to the cell. In the case that the UE 101 receives the RRC release message, then the UE 101 may enter a RRC_IDLE state.

In some embodiments of the present application, the UE 101 may not receive any response message from the MN 102 before the timer expires. The UE 101 would perform a re-establishment procedure (i.e., a RRC re-establishment procedure) after the timer expires.

In addition, the UE 101 may also be configured with a CHO procedure. The CHO procedure is defined as a handover procedure that is executed by the UE 101 when one or more handover execution conditions are met. In the CHO procedure, a UE 101 may start evaluating execution condition(s) after receiving the CHO configuration information, and stop evaluating the execution condition during the CHO execution once the execution condition(s) is met.

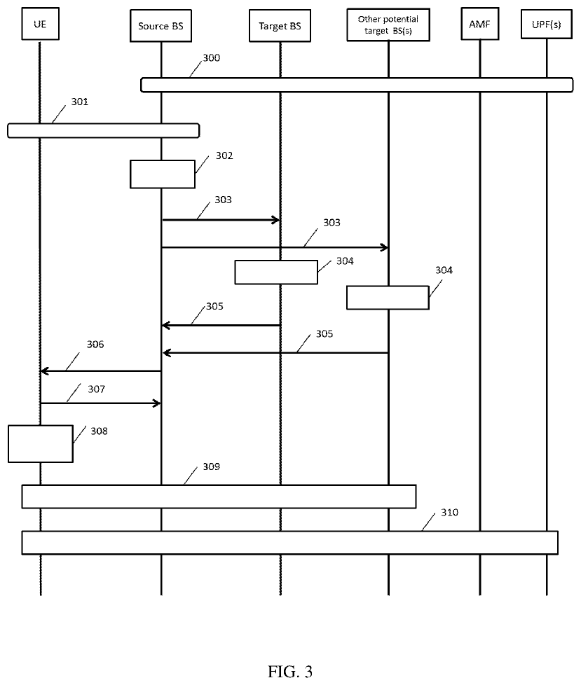

For example, FIG. 3 illustrates an exemplary flowchart of a CHO procedure in accordance with some embodiments of the present application. As shown in FIG. 3, it depicts a basic conditional handover scenario where neither the access and mobility management function (AMF) nor the user plane functions (UPFs) changes.

Referring to FIG. 3, in step 300, an AMF may provide the UE context of a UE to the source base station (BS). The UE context may contain information regarding roaming and access restrictions of the UE.

In step 301, the source BS may transmit measurement configuration information to the UE. The UE may report the measurement result to the source BS based on the measurement configuration information.

In step 302, the source BS may decide to use a CHO for the UE based on the measurement result reported by the UE.

In step 303, the source BS may transmit a CHO request message to one or more candidate BSs. For example, the one or more candidate BSs may include a target BS and other potential target BS(s).

In step 304, the target BS and other potential target BS(s) may perform admission control to decide whether to allow the CHO of the UE after receiving the CHO request message from the source BS.

In step 305, based on the admission control result, at least one of the target BS and other potential target BS(s) may transmit a CHO response message to the source BS. The CHO response message may include CHO configuration for one or more candidate cells.

In step 306, the source BS may transmit a RRC reconfiguration message to the UE. The RRC reconfiguration message may include conditional handover (CHO) configuration information indicating a set of CHO configurations and a set of execution conditions for a set of cells, each cell is associated with a CHO configuration and an execution condition. The set of cells may include the one or more candidate cells provided by at least one of the target BS and other potential target BS(s).

The CHO configuration associated with a cell may include parameters for the UE to perform handover to the cell. For example, the CHO configuration associated with a cell may include parameters for the UE to access the cell and/or perform data transmission with the cell.

The execution condition may include one or two trigger conditions. For example, in the case that the execution condition includes one trigger condition, the trigger condition may be an A3 event or an A5 event as specified in 3GPP standard document TS38.331. In the case that the execution condition includes two trigger conditions, the two trigger conditions may be an A3 event and an A5 event as specified in 3GPP standard document TS38.331. In addition, only a single reference signal (RS) type may be used for evaluating the execution condition of a single cell and at most two different execution quantities can be configured simultaneously for evaluating the execution condition of a single cell. For example, the two different execution quantities may be reference signal receiving power (RSRP) and reference signal receiving quality (RSRQ), or RSRP and signal to interference plus noise ratio (SINR), or the like. In some embodiments of the present application, more than one execution condition may be satisfied, that is, more than one cell is suitable for the UE's handover. In this case, the UE can select a cell for performing CHO based on the execution quantity.

After receiving the RRC reconfiguration message, in step 307, the UE may transmit a RRC reconfiguration complete message to the source BS.

In step 308, the UE may maintain the connection with the source BS and start evaluating the set of execution conditions for the set of cells. Before any execution condition is satisfied, when receiving a handover (HO) command without CHO configuration, the UE may perform the HO procedure regardless of any previously received CHO configuration information. Otherwise, in the case that at least one execution condition for at least one cell is satisfied, in step 309, the UE may detach from the source BS and perform (or apply) a CHO procedure to a cell selected from the at least one cell. The selected cell may be referred to as a target cell.

Performing a CHO procedure to the selected cell may include applying the corresponding CHO configuration for the selected cell. When performing the CHO procedure, i.e., from the time when the UE starts synchronization with the selected cell, the UE does not monitor the source BS anymore. The UE may complete the CHO procedure by transmitting a RRC reconfiguration complete message to the target cell.

In step 310, the UE, the source BS, the target BS, and the core network (e.g., AMF and/or UPF(s)) may perform data forwarding and path switch.

In MR-DC operation, PCell, PSCell, or SCells may be operated in a shared (e.g., unlicensed) spectrum. A base station (BS) (e.g., the MN 102 or the SN 103 as shown in FIG. 1) may be operated in either dynamic access mode or semi-static channel access mode as specified in TS 37.213. In both channel access modes, the BS and UE may apply a LBT before performing a transmission on a cell configured with a shared spectrum channel access. When a LBT is applied, the transmitter listens to/senses the channel to determine whether the channel is free or busy and performs transmission only if the channel is sensed free.

For example, LBT is executed by performing energy detection on a certain channel. If the detected power of the channel is below a predefined threshold, LBT is successful, which suggests that the channel is deemed as empty and available for transmission. Only when LBT is successful, can the transmitter start the transmission on the channel and occupy the channel up to the maximum channel occupancy time (MCOT). Otherwise, if the detected power of the channel exceeds a predefined threshold, LBT is failed. Accordingly, the transmitter cannot start the transmission and will continue performing LBT until a successful LBT is obtained.

When a UE (e.g., UE 101 as shown in FIG. 1) detects a consistent uplink LBT failure for different cells, it may take different actions. In an embodiment of the present application, the detection is per bandwidth part (BWP) and based on all uplink transmissions within a BWP. In an embodiment of the present application, the consistent uplink LBT failure may be defined as specified in TS 38.321. For example, when a medium access control (MAC) layer receives a LBT failure indication from a lower layer (e.g., physical layer), it may start a timer (e.g., lbt-FailureDetectionTimer as specified in TS 38.321). Before the timer expires, in the case that another LBT failure indication is received from the lower layer, a LBT counter will be incremented by 1. Before the timer expires, in the case that the value of the LBT counter is larger than or equal to a threshold value (e.g., lbt-FailurelnstanceMaxCount as specified in TS 38.321), a consistent uplink LBT failure is detected by the UE.

When a consistent uplink LBT failure is detected for a SCell, the UE may report the consistent uplink LBT failure to the corresponding BS (i.e., the MN 102 for MCG or SN 103 for SCG) via a MAC control element (CE) on a different serving cell than the SCell where the consistent uplink LBT failure is detected. In the case that no resource is available to transmit the MAC CE, a scheduling request (SR) can be transmitted by the UE.

When a consistent uplink LBT failure is detected on SpCell (i.e., PCell or PSCell), the UE may switch to another uplink BWP with the configured RACH resources on that cell, initiate a random access channel (RACH) procedure, and report the consistent uplink LBT failure via a MAC CE. For PSCell, in the case that the consistent uplink LBT failures are detected on all the uplink (UL) BWPs with configured RACH resources, the UE may declare a SCG RLF (i.e., RLF in the SCG) and report the SCG RLF to the MN via SCG failure information. For PCell, in the case that the consistent uplink LBT failures are detected on all the UL BWPs with configured RACH resources, the UE may declare a MCG RLF (i.e., RLF in the MCG).

In the MR-DC scenario, a UE 101 may be configured with the MCG link recovery procedure and the CHO procedure. In addition, the UE 101 may also perform LBT to detect the consistent uplink LBT failure in the MCG. However, how to handle the association between a fast MCG link recovery procedure and a CHO procedure and between the fast MCG link recovery procedure and the LBT has not been discussed in 3GPP 5G NR technology yet.

For example, the following issues may be involved in a fast MCG link recovery procedure when considering the CHO procedure and the LBT.

The first issue is how to handle CHO configuration mismatching during a fast MCG link recovery.

In fact, CHO configuration mismatching may also occur during the CHO procedure. For example, a UE 101 may receive one or more CHO configurations for one or more target candidate cells. At a certain time, the source BS may decide to modify the current configuration of the source BS. Before transmitting the modified configuration of the source BS to the UE, the source BS may transmit a CHO request to at least one target candidate cell so as to obtain a new CHO configuration of the at least one target candidate cell, and then the source BS may indicate the modified configuration of the source BS and the new CHO configuration of the at least one target candidate cell in a same RRC message. However, when the source BS is contacting with the at least one target candidate cell to obtain the new CHO configuration of the at least one target candidate cell, the execution condition for a target candidate cell may be fulfilled, and thus the UE 101 may perform a CHO procedure towards the target candidate cell according to a CHO configuration that the target candidate cell may not support any longer.

To solve the above problem, according to an embodiment of the present application, the source BS may first remove the CHO configuration(s) for the cell(s). After that, the source BS may obtain the new CHO configuration of the at least one target candidate cell. According to another embodiment of the present application, the source BS may first suspend the CHO configuration(s) for the cell(s). After that, the source BS may obtain the new CHO configuration of the at least one target candidate cell.

However, the above solutions for solving the CHO configuration mismatching do not involve a fast MCG link recovery procedure. In the case that a fast MCG link recovery is configured, once a RLF happens in MCG, as shown in FIG. 2, the UE 101 starts a timer T316 and transmits a MCGFailureInformation message to the MN 102 via the SN 103. After receiving the MCGFailureInformation message, the MN 102 may transmit one or more handover requests to one or more target candidate cells to obtain the configuration of the one or more target candidate cells. During this procedure, the CHO configuration for the one or more target candidate cells may be modified.

After that, the MN 102 may transmit a handover command (e.g., a RRC reconfiguration message including a reconfiguration with sync information element (IE)) to UE via the SN 103. In some cases, the UE 101 may perform a CHO procedure once the execution condition for a cell is met when T316 is running. However, the modified CHO configuration for a certain cell may be not known by the UE 101, which may affect the subsequent CHO procedure.

The second issue is how to handle out of date CHO configuration during a fast MCG link recovery.

As stated above, after receiving the MCGFailureInformation message, the MN 102 may transmit one or more handover requests to one or more target candidate cells to obtain the configuration of the one or more target candidate cells. During this procedure, the CHO configuration for the one or more target candidate cells may be modified. After that, the MN 102 may transmit a handover command to the UE 101 via the SN 103. After receiving the handover command, the UE 101 may initiate a handover procedure. Once the handover procedure fails, the UE 101 may initiate a re-establishment procedure. During the re-establishment procedure, in the case that cell A with CHO configuration is selected, the UE 101 may perform a CHO procedure for cell A. However, performing a CHO procedure for cell A may fail because the CHO configuration may be out-of-date (e.g., modified previously).

The third issue is how to handle the association between an uplink LBT failure and a fast MCG link recovery procedure.

As stated above, in the case that the consistent uplink LBT failures are detected on all the UL BWPs with configured RACH resources, the UE 101 may declare a MCG RLF. In response to the MCG RLF, the UE 101 may transmit MCG failure information to the MN 102 via the SN 103. However, how to handle the MCG failure information due to the consistent uplink LBT failure during fast MCG link recovery has not been discussed yet.

Given the above, embodiments of the present application can provide solutions for fast MCG link recovery considering CHO and LBT. Accordingly, embodiments of the present application can solve the above three issues. More details on embodiments of the present application will be illustrated in the following text in combination with the appended drawings.

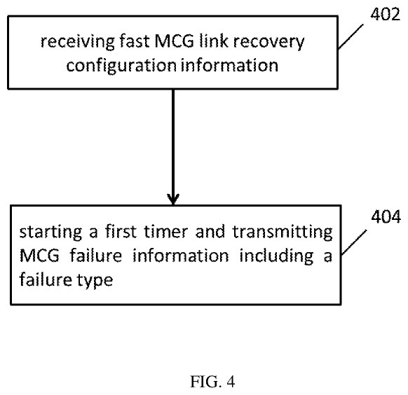

FIG. 4 illustrates a flow chart of a method for fast MCG link recovery considering CHO and LBT in accordance with some embodiments of the present application. The method may be performed by a UE 101 as shown in FIG. 1. For example, the UE 101 may be in the MR-DC scenario where the UE 101 connects to an MN 102 and an SN 103.

As shown in FIG. 4, in step 402, the UE 101 may receive fast MCG link recovery configuration information from a BS, for example, the MN 102 as shown in FIG. 1. When the UE 101 receives the fast MCG link recovery configuration information, the UE 101 is allowed to use a fast MCG link recovery procedure when a RLF in a MCG happens. In an embodiment of the present application, the fast MCG link recovery configuration information may include a value for a timer associated with the fast MCG link recovery procedure. For example, the timer may be T316 as specified in 3GPP standard documents.

After that, a RLF in a MCG may happen for the UE 101. According to some embodiments of the present application, the UE 101 may declare a radio link failure in a MCG in response to one of: an out-of-sync timer expires, a random access problem occurs, a maximum number of retransmissions has been reached, and a consistent uplink LBT failure is detected.

In an embodiment of the present application, the out-of-sync timer may be T310 as specified in 3GPP standard documents. For example, the T310 may be started when detecting physical layer problems for the SpCell, i.e. when receiving a number of consecutive out-of-sync indications from lower layers. The number of consecutive out-of-sync indications may be N310 as specified in 3GPP standard documents.

In another embodiment of the present application, the random access problem may be indicated by an indication from a MCG medium access control (MAC) layer.

In yet another embodiment of the present application, a maximum number of retransmissions being reached may be indicated by an indication from a MCG radio link control (RLC) layer.

In yet another embodiment of the present application, the consistent uplink LBT failure being detected may refer to that the consistent uplink LBT failures are detected on all the UL BWPs with configured RACH resources for the PCell.

In response to the RLF in the MCG, in step 404, the UE 101 may start a first timer associated with a fast MCG link recovery procedure and transmit MCG failure information including a failure type to the MN 102 via the SN 103. For example, the timer associated with the fast MCG link recovery procedure is T316 as specified in 3GPP standard documents. The failure type indicates that the RLF in the MCG is due to one of: an out-of-sync timer expires; a random access problem occurs; a maximum number of retransmissions has been reached; and a consistent uplink LBT failure is detected.

For example, in the case that the RLF in the MCG is declared based on that an out-of-sync timer (e.g., T310) expires, the UE 101 may set the failure type to be t310-expiry. In the case that the RLF in the MCG is declared based on that a random access problem occurs, the UE 101 may set the failure type to be randomAaccessProblem. In the case that the RLF in the MCG is declared based on that a maximum number of retransmissions has been reached, the UE 101 may set the failure type to be rlc-MaxNumRetx. In the case that the RLF in the MCG is declared based on that the consistent uplink LBT failure is detected, the UE 101 may set the failure type to be mcg-lbtFailure or LBT failure.

Prior to the RLF in the MCG, the UE 101 may also receive a RRC reconfiguration message including first conditional handover CHO configuration information indicating a first set of CHO configurations and a first set of execution conditions for a first set of cells, each cell of the first set of cells is associated with a CHO configuration of the first set of CHO configurations and an execution condition of first set of execution conditions. The set of CHO configurations means one or more CHO configurations, the set of execution conditions means one or more execution conditions, and the set of cells means one or more cells. In some embodiments of the present application, the set of cells includes one or more candidate cells indicated in the CHO configuration message from at least one of the target BS and other potential target BS(s), as shown in step 305 of FIG. 3.

The CHO configuration associated with a cell may include parameters for the UE to perform handover to the cell. For example, the CHO configuration associated with a cell includes parameters for the UE to access the cell and/or perform data transmission with the cell.

The execution condition includes one or two trigger conditions. For example, in the case that the execution condition includes one trigger condition, the trigger condition may be an A3 event or an A5 event as specified in 3GPP standard document TS38.331. In the case that the execution condition includes two trigger conditions, the two trigger conditions may be an A3 event and an A5 event as specified in 3GPP standard document TS38.331. In addition, only a single RS type may be used for evaluating the execution condition of a single cell and at most two different execution quantities can be configured simultaneously for evaluating the execution condition of a single cell. For example, the two different execution quantities may be RSRP and RSRQ, or RSRP and SINR, or the like.

According to some embodiments of the present application, when the first timer (e.g., T316) is running, the UE 101 may receive a RRC reconfiguration message including first indication information from the MN 102 via the SN 103. The first indication information may indicate removing a part of CHO configurations or all CHO configurations of the first set of CHO configurations and/or a part of execution conditions or all execution conditions of the first set of execution conditions. After receiving the first indication information, the UE 101 may not evaluate the execution conditions which are indicated to be removed and/or may not perform CHO procedure for a cell for which the CHO configuration is indicated to be removed, even though the execution condition for the cell is met.

In an embodiment of the present application, the RRC reconfiguration message may further include second indication information indicating not to stop the first timer in response to receiving the RRC reconfiguration message including the first indication information. After receiving the RRC reconfiguration message, the UE 101 will not stop the first timer. In this case, the second indication information may indicate to continue the first timer or to restart the first timer.

In another embodiment of the present application, after receiving the first indication information to remove CHO configuration(s) and/or execution condition(s), the UE 101 may receive second CHO configuration information indicating a second set of CHO configurations and a second set of execution conditions for a second set of cells, each cell of the second set of cells is associated with a CHO configuration of the second set of CHO configurations and an execution condition of second set of execution conditions. In an embodiment of the present application, the second set of cells may include one or more cells of the first set of cells as well as zero or more cells other than the first set of cells. For example, the second set of cells may include the cell(s) for which the CHO configuration(s) and/or execution condition(s) are removed, which means that the MN 102 may reconfigure the CHO configuration(s) and/or execution condition(s) for these cell(s). In another embodiment of the present application, the second set of cells may not include any cell of the first set of cells.

In another embodiment of the present application, the RRC reconfiguration message may not include second indication information. In this case, the UE 101 may still not stop the first timer in response to receiving the RRC reconfiguration message including the first indication information.

In another embodiment of the present application, the RRC reconfiguration message may not include second indication information. In this case, the UE 101 may still not stop the first timer in response to receiving the RRC reconfiguration message including the first indication information. The RRC reconfiguration message may not include a reconfiguration with sync information element (IE).

According to some embodiments of the present application, when the first timer (e.g., T316) is running, the UE may receive a RRC reconfiguration message including third indication information from the MN 102 via the SN 103. The third indication information may indicate suspending a part of CHO configurations or all CHO configurations of the first set of CHO configurations and/or a part of execution conditions or all execution conditions of the first set of execution conditions. After receiving the third indication information, the UE 101 may not evaluate the execution conditions which are indicated to be suspended and/or may not perform CHO procedure for a cell for which the CHO configuration is indicated to be suspended, even though the execution condition for the cell is met.

In an embodiment of the present application, the RRC reconfiguration message may further include fourth indication information indicating not to stop the first timer in response to receiving the RRC reconfiguration message including the third indication information. After receiving the RRC reconfiguration message, the UE 101 will not stop the first timer.

In another embodiment of the present application, the RRC reconfiguration message may not include fourth indication information. In this case, the UE 101 may still not stop the first timer in response to receiving the RRC reconfiguration message including the third indication information.

After the above process, in some cases, the UE 101 may receive a handover command (e.g., a RRC reconfiguration message including a reconfiguration with sync information element (IE)) from the MN 102 via the SN 103 when the first timer is running. In response to the handover command, the UE 101 may stop the first timer and initiate a handover procedure. In some other cases, the UE 101 may evaluate the current execution condition(s) when the first timer is running, and will perform a CHO procedure and stop the first timer once the execution condition for a cell is met.

According to some embodiments of the present application, the UE 101 may also receive an indication in one of first CHO configuration information, first indication information, and third indication information. The indication may indicate that the UE 101 is allowed to transmit a cell identity of a cell for which the corresponding execution condition is met.

In an embodiment of the present application, after receiving the first CHO configuration information, the UE 101 may evaluate the first set of execution conditions based on the first CHO configuration information. For example, for each cell of the first set of cells, the UE 101 may measure the execution quantities (for example, RSRP and RSRQ) of the reference signal (for example, channel state information reference signal) for the cell, and evaluate whether the one or two trigger conditions (for example, A3 and/or A5) for the cell is satisfied. In the case that the at least one cell for which the corresponding at least one execution condition is met, the UE 101 may transmit the at least one cell identity of at least one cell for which the corresponding at least one execution condition is met when the first timer is running.

According to some embodiments of the present application, when the first timer is running, the UE 101 may receive a RRC reconfiguration message including reconfiguration with sync IE (e.g., a reconfigurationWithSync IE as specified in 3GPP standard documents) for a cell. The RRC reconfiguration message may include fifth indication information indicating removing a part of CHO configurations of the first set of CHO configurations or all CHO configurations of the first set of CHO configurations.

According to some embodiments of the present application, when the first timer is running, the UE 101 may receive a RRC reconfiguration message including reconfiguration with sync IE (e.g., a reconfigurationWithSync IE as specified in 3GPP standard documents) for a cell. The UE 101 may remove the first set of CHO configurations in response to receiving the RRC reconfiguration message.

According to some embodiments of the present application, when the first timer is running, the UE 101 may receive a RRC reconfiguration message including a reconfiguration with sync IE (e.g., a reconfigurationWithSync IE as specified in 3GPP standard documents) for a cell. In response to receiving the RRC reconfiguration message including a reconfiguration with sync IE, the UE 101 may perform a HO procedure to the cell according to the RRC reconfiguration message. In the case that the HO to the cell fails, the UE may initiate a procedure.

In an embodiment of the present application, in response to the handover procedure failure, the UE 101 may initiate a RRC re-establishment procedure without performing CHO. For example, during the re-establishment procedure, even a cell with CHO configuration is selected, the UE 101 may not perform a CHO procedure for cell. Instead, the UE 101 may transmit a re-establishment request to the cell.

In another embodiment of the present application, in response to the handover procedure failure, the UE 101 may remove the first set of CHO configurations.

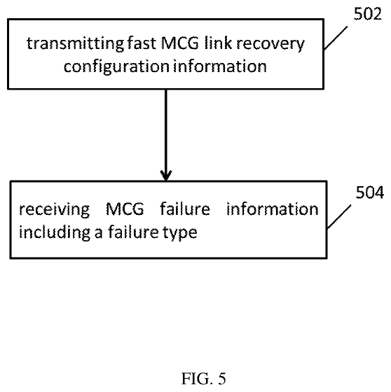

FIG. 5 illustrates a flow chart of a method for fast MCG link recovery considering CHO and LBT in accordance with some other embodiments of the present application. The method may be performed by a MN 102 as shown in FIG. 1.

As shown in FIG. 5, in step 502, the MN 102 may receive fast MCG link recovery configuration information to a UE, for example, the UE 101 as shown in FIG. 1. When the UE 101 receives the fast MCG link recovery configuration information, the UE 101 is allowed to use a fast MCG link recovery procedure when a RLF in a MCG happens. In an embodiment of the present application, the fast MCG link recovery configuration information may include a value for a timer associated with the fast MCG link recovery procedure. For example, the timer may be T316 as specified in 3GPP standard documents.

Then, the MN 102 may receive MCG failure information including a failure type from the UE 101 via the SN 103. The failure type may indicate that the RLF in the MCG is due to one of: an out-of-sync timer (e.g., T310 as specified in 3GPP standard documents) expires; a random access problem occurs; a maximum number of retransmissions has been reached; and a consistent uplink LBT failure is detected.

For example, in the case that the RLF in the MCG is declared based on that an out-of-sync timer (e.g., T310) expires, the failure type may be t310-expiry. In the case that the RLF in the MCG is declared based on that a random access problem occurs, the failure type may be randomAaccessProblem. In the case that the RLF in the MCG is declared based on that a maximum number of retransmissions has been reached, the failure type may be rlc-MaxNumRetx. In the case that the RLF in the MCG is declared based on that the consistent uplink LBT failure is detected, the failure type may be mcg-lbtFailure or LBT failure.

Prior to receiving the MCG failure information, the MN 102 may also transmit a RRC reconfiguration message including first conditional handover CHO configuration information indicating a first set of CHO configurations and a first set of execution conditions for a first set of cells, each cell of the first set of cells is associated with a CHO configuration of the first set of CHO configurations and an execution condition of first set of execution conditions. The set of CHO configurations means one or more CHO configurations, the set of execution conditions means one or more execution conditions, and the set of cells means one or more cells. In some embodiments of the present application, the set of cells includes one or more candidate cells indicated in the CHO configuration message from at least one of the target BS and other potential target BS(s), as shown in step 305 of FIG. 3.

The CHO configuration associated with a cell may include parameters for the UE to perform handover to the cell. For example, the CHO configuration associated with a cell includes parameters for the UE to access the cell and/or perform data transmission with the cell.

The execution condition includes one or two trigger conditions. For example, in the case that the execution condition includes one trigger condition, the trigger condition may be an A3 event or an A5 event as specified in 3GPP standard document TS38.331. In the case that the execution condition includes two trigger conditions, the two trigger conditions may be an A3 event and an A5 event as specified in 3GPP standard document TS38.331. In addition, only a single RS type may be used for evaluating the execution condition of a single cell and at most two different execution quantities can be configured simultaneously for evaluating the execution condition of a single cell. For example, the two different execution quantities may be RSRP and RSRQ, or RSRP and SINR, or the like.

According to some embodiments of the present application, when a first timer (e.g. T316) associated with a fast MCG link recovery procedure is running, the MN 102 may transmit a RRC reconfiguration message including first indication information to the UE 101 via the SN 103. The first indication information may indicate removing a part of CHO configurations or all CHO configurations of the first set of CHO configurations and/or a part of execution conditions or all execution conditions of the first set of execution conditions.

In an embodiment of the present application, the RRC reconfiguration message may further include second indication information indicating not to stop the first timer in response to receiving the RRC reconfiguration message including the first indication information. In this case, the second indication information may indicate to continue the first timer or to restart the first timer.

In another embodiment of the present application, after transmitting the first indication information to remove CHO configuration(s) and/or execution condition(s), the MN 102 may transmit second CHO configuration information indicating a second set of CHO configurations and a second set of execution conditions for a second set of cells to the UE 101 via the SN 102. Each cell of the second set of cells is associated with a CHO configuration of the second set of CHO configurations and an execution condition of second set of execution conditions. In an embodiment of the present application, the second set of cells may include one or more cells of the first set of cells as well as zero or more cells other than the first set of cells. For example, the second set of cells may include the cell(s) for which the CHO configuration(s) and/or execution condition(s) are removed, which means that the MN may reconfigure the CHO configuration(s) and/or execution condition(s) for these cell(s). In another embodiment of the present application, the second set of cells may not include any cell of the first set of cells.

In another embodiment of the present application, the RRC reconfiguration message including the first indication information may not include a reconfiguration with sync information element (IE).

According to some embodiments of the present application, when a first timer (e.g. T316) associated with a fast MCG link recovery procedure is running, the MN 102 may transmit a RRC reconfiguration message including third indication information to the UE 101 via the SN 103. The third indication information may indicate suspending a part of CHO configurations or all CHO configurations of the first set of CHO configurations and/or a part of execution conditions or all execution conditions of the first set of execution conditions.

In an embodiment of the present application, the RRC reconfiguration message may further include fourth indication information indicating not to stop the first timer in response to receiving the RRC reconfiguration message including the third indication information.

According to some embodiments of the present application, the MN 102 may also transmit an indication in one of first CHO configuration information, first indication information, and third indication information to the UE 101. The indication may indicate that UE 101 is allowed to transmit a cell identity of a cell for which the corresponding execution condition is met.

In an embodiment of the present application, when a first timer (e.g. T316) associated with a fast MCG link recovery procedure is running, the MN 102 may receive at least one cell identity of at least one cell for which the corresponding at least one execution condition is met from the UE 101 via the SN 103.

According to some embodiments of the present application, when a first timer (e.g. T316) associated with a fast MCG link recovery procedure is running, the MN 102 may transmit a RRC reconfiguration message including reconfiguration with sync IE (e.g., a reconfigurationWithSync IE as specified in 3GPP standard documents) to the UE 101 via the SN 103. The RRC reconfiguration message may include fifth indication information indicating removing a part of CHO configurations of the first set of CHO configurations or all CHO configurations of the first set of CHO configurations.

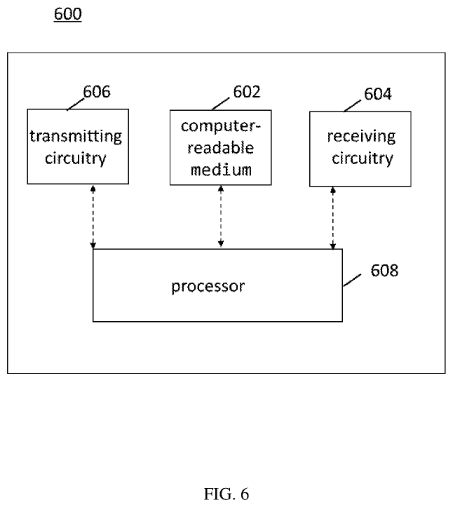

FIG. 6 illustrates a simplified block diagram of an apparatus 600 for CHO and fast MCG link recovery according to some embodiments of the present application. The apparatus 600 may be a UE 101 as shown in FIG. 1.

Referring to FIG. 6, the apparatus 600 may include at least one non-transitory computer-readable medium 602, at least one receiving circuitry 604, at least one transmitting circuitry 606, and at least one processor 608. In some embodiment of the present application, at least one receiving circuitry 604 and at least one transmitting circuitry 606 and be integrated into at least one transceiver. The at least one non-transitory computer-readable medium 602 may have computer executable instructions stored therein. The at least one processor 608 may be coupled to the at least one non-transitory computer-readable medium 602, the at least one receiving circuitry 604 and the at least one transmitting circuitry 606. The computer executable instructions can be programmed to implement a method with the at least one receiving circuitry 604, the at least one transmitting circuitry 606 and the at least one processor 608 The method can be a method according to an embodiment of the present application, for example, the method shown in FIG. 4.

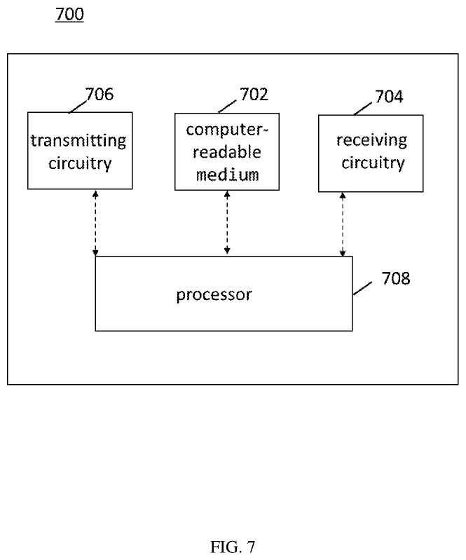

FIG. 7 illustrates a simplified block diagram of an apparatus 700 for fast MCG link recovery according to some embodiments of the present application. The apparatus 700 may be a MN 102 as shown in FIG. 1.

Referring to FIG. 7, the apparatus 700 may include at least one non-transitory computer-readable medium 702, at least one receiving circuitry 704, at least one transmitting circuitry 706, and at least one processor 708. In some embodiment of the present application, at least one receiving circuitry 704 and at least one transmitting circuitry 706 and be integrated into at least one transceiver. The at least one non-transitory computer-readable medium 702 may have computer executable instructions stored therein. The at least one processor 708 may be coupled to the at least one non-transitory computer-readable medium 702, the at least one receiving circuitry 704 and the at least one transmitting circuitry 706. The computer executable instructions can be programmed to implement a method with the at least one receiving circuitry 704, the at least one transmitting circuitry 706 and the at least one processor 708 The method can be a method according to an embodiment of the present application, for example, the method shown in FIG. 5.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for emotion recognition from speech as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

What is claimed is:

1. An apparatus, comprising:
receive circuitry;
transmit circuitry; and
a processor coupled to the receive circuitry and the transmit circuitry, wherein one or more of the receive circuitry, the transmit circuitry, or the processor are configured to cause the apparatus to:
receive master cell group (MCG) link recovery configuration information; and
start, in response to a radio link failure (RLF) in a MCG, a first timer associated with a MCG link recovery procedure and transmit MCG failure information including a failure type, wherein the failure type indicates that the RLF in the MCG is due to at least one of:
an out-of-sync timer expires;
a random access problem occurs;
a maximum number of retransmissions has been reached; or
a consistent uplink listen before talk (LBT) failure is detected.

2. The apparatus of claim 1, wherein one or more of the receive circuitry, the transmit circuitry, or the processor are configured to cause the apparatus to receive a radio resource control (RRC) reconfiguration message including first conditional handover (CHO) configuration information indicating a first set of CHO configurations and a first set of execution conditions for a first set of cells prior to the RLF, wherein each cell of the first set of cells is associated with a CHO configuration of the first set of CHO configurations and an execution condition of first set of execution conditions.

3. The apparatus of claim 2, wherein one or more of the receive circuitry, the transmit circuitry, or the processor are configured to cause the apparatus to:
receive a RRC reconfiguration message including first indication information when the first timer is running, wherein the first indication information indicates to remove one or more of a part of CHO configurations of the first set of CHO configurations, all CHO configurations of the first set of CHO configurations a part of execution conditions of the first set of execution conditions, or all execution conditions of the first set of execution conditions.

4. The apparatus of claim 3, wherein the RRC reconfiguration message comprises second indication information indicating not to stop the first timer in response to receiving the RRC reconfiguration message including the first indication information.

5. The apparatus of claim 4, wherein the second indication information indicates to continue the first timer or restart the first timer.

6. The apparatus of claim 3, wherein one or more of the receive circuitry, the transmit circuitry, or the processor are configured to cause the apparatus to:
receive second CHO configuration information indicating a second set of CHO configurations and a second set of execution conditions for a second set of cells, wherein each cell of the second set of cells is associated with a CHO configuration of the second set of CHO configurations and an execution condition of second set of execution conditions.

7. The apparatus of claim 3, wherein one or more of the receive circuitry, the transmit circuitry, or the processor are configured to cause the apparatus to not stop the first timer in response to receiving the RRC reconfiguration message including the first indication information.

8. The apparatus of claim 3, wherein one or more of the receive circuitry, the transmit circuitry, or the processor are configured to cause the apparatus to not stop the first timer in response to receiving the RRC reconfiguration message including the first indication information, wherein the RRC reconfiguration message does not comprise a reconfiguration with sync information element (IE).

9. The apparatus of claim 2, wherein one or more of the receive circuitry, the transmit circuitry, or the processor are configured to cause the apparatus to:
receive an RRC reconfiguration message including third indication information when the first timer is running, wherein the third indication information indicates suspending a part of CHO configurations of the first set of CHO configurations or all CHO configurations of the first set of CHO configurations.

10. The apparatus of claim 9, wherein the RRC reconfiguration message comprises fourth indication information indicating not to stop the first timer in response to receiving the RRC reconfiguration message including the third indication information.

11. The apparatus of claim 9, wherein one or more of the receive circuitry, the transmit circuitry, or the processor are configured to cause the apparatus to not stop the first timer in response to receiving the RRC reconfiguration message including the third indication information.

12-18. (canceled)

19. An apparatus, comprising:
receive circuitry;
transmit circuitry; and
a processor coupled to the receive circuitry and the transmit circuitry, wherein one or more of the receive circuitry, the transmit circuitry, or the processor are configured to cause the apparatus to:
transmit master cell group (MCG) link recovery configuration information; and
receive MCG failure information including a failure type, wherein the failure type indicates that a radio link failure (RLF) in a MCG is due to at least one of:
an out-of-sync timer expires;
a random access problem occurs;
a maximum number of retransmissions has been reached; or
a consistent uplink listen before talk (LBT) failure is detected.

20. The apparatus of claim 19, wherein one or more of the receive circuitry, the transmit circuitry, or the processor are configured to cause the apparatus to transmit a radio resource control (RRC) reconfiguration message including first conditional handover (CHO) configuration information indicating a first set of CHO configurations and a first set of execution conditions for a first set of cells prior to receiving the MCG failure information, wherein each cell of the first set of cells is associated with a CHO configuration of the first set of CHO configurations and an execution condition of first set of execution conditions.

21. The apparatus of claim 20, wherein one or more of the receive circuitry, the transmit circuitry, or the processor are configured to cause the apparatus to:
transmit a RRC reconfiguration message including first indication information when a first timer is running, wherein the first indication information indicates to remove one or more of a part of CHO configurations of the first set of CHO configurations, all CHO configurations of the first set of CHO configurations, a part of execution conditions of the first set of execution conditions, or all execution conditions of the first set of execution conditions.

22. The apparatus of claim 21, wherein the RRC reconfiguration message comprises second indication information indicating not to stop the first timer in response to receiving the RRC reconfiguration message including the first indication information.

23. The apparatus of claim 22, wherein the second indication information indicates to continue the first timer or restart the first timer.

24. The apparatus of claim 21, wherein one or more of the receive circuitry, the transmit circuitry, or the processor are configured to cause the apparatus to:
transmit second CHO configuration information indicating a second set of CHO configurations and a second set of execution conditions for a second set of cells, wherein each cell of the second set of cells is associated with a CHO configuration of the second set of CHO configurations and an execution condition of second set of execution conditions.

25. The apparatus of claim 21, wherein the RRC reconfiguration message does not comprise a reconfiguration with sync information element (IE).

26. The apparatus of claim 20, wherein one or more of the receive circuitry, the transmit circuitry, or the processor are configured to cause the apparatus to:
transmit a radio resource control (RRC) reconfiguration message including third indication information when a first timer is running, wherein the third indication information indicates suspending a part of CHO configurations of the first set of CHO configurations or all CHO configurations of the first set of CHO configurations.

27-32. (canceled)

33. A method, comprising:
receiving master cell group (MCG) link recovery configuration information; and
starting, in response to a radio link failure (RLF) in a MCG, a first timer associated with a fast MCG link recovery procedure, and transmitting MCG failure information including a failure type, wherein the failure type indicates that the RLF in the MCG is due to at least one of:
an out-of-sync timer expires;
a random access problem occurs;
a maximum number of retransmissions has been reached; or
a consistent uplink listen before talk (LBT) failure is detected.
